(19) United States
(12) Patent Application Publication
(10) Pub. No.: US 2011/0189452 A1
(43) Pub. Date: Aug. 4, 2011

(54) Crosslinked Graphene and Graphite Oxide

(75) Inventors: John Lettow, Washington, DC (US); Dan Scheffer, Columbia, MD (US); Vipin Varma, Columbia, MD (US); Kate Redmond, Baltimore, MD (US)

(73) Assignee: VORBECK MATERIALS CORP., Jessup, MD (US)

(21) Appl. No.: 12/848,148

(22) Filed: Jul. 31, 2010

Related U.S. Application Data
(60) Provisional application No. 61/230,633, filed on Jul. 31, 2009.

(51) Int. Cl. C01B 31/02; C01B 31/00; B32B 9/00; B05D 3/10; B82Y 30/00

(52) U.S. Cl. 428/220; 423/448; 423/415.1; 427/372.2; 977/734

(57) ABSTRACT

Compositions comprising crosslinked graphene sheets and/or graphite oxide and having essentially no polymer binder and methods of making crosslinked graphene sheets and/or graphite oxide. The compositions can be made by crosslinking coatings comprising graphene sheets and/or graphite oxide.

### RELATED APPLICATIONS

This application claims priority to, and the benefit of U.S. Provisional Patent Application Ser. No. 61/230,633, filed on Jul. 31, 2009, entitled “Crosslinked Graphene and Graphite Oxide,” which is incorporated herein by reference in its entirety.

### FIELD OF THE INVENTION

The present invention relates to compositions comprising crosslinked graphene sheets and/or graphite oxide and methods of making crosslinked graphene sheets and/or graphite oxide.

### BACKGROUND

Graphene sheets and graphite oxide have recently become the objects of increased study. These materials can have many useful properties, such as electrical conductivity, thermal conductivity, barrier properties, stiffness, strength, etc. However, when used without a polymer binder, they can be difficult to process into the forms required for many applications. In many cases, they lack sufficient internal cohesion and/or adhesion to a substrate to fulfill the needs (such as electrical conductivity) of many applications. It would thus be desirable to obtain compositions of graphene sheets and/or graphite oxide that can be processed into useful forms and have good physical properties, such as electrical conductivity.

Nature 2007, 448, 457-460 discloses the preparation and characterization of graphene oxide paper. ACS Nano 2008, 2, 463-470 discloses a paper-like material made from graphene oxide sheets and Mg²⁺ and Ca²⁺ ions. Adv. Mater. 2008, 20, 3557-3561 discloses graphene paper made by the filtration of a graphene dispersion through a membrane filter. WO 2008/143829 discloses a macroscale sheet laminate that includes graphene oxide sheets layered one on another to form a paper-like laminated product.

### SUMMARY OF THE INVENTION

Disclosed and claimed herein are compositions comprising crosslinked graphene sheets and/or graphite oxide and methods of making compositions comprising crosslinked graphene sheets and/or graphite oxide.

### DETAILED DESCRIPTION OF THE INVENTION

Crosslinking may be done by a free radical or other process. Any suitable crosslinking method may be used, such as free radical initiator, sulfur, radiation, electron beam, thermal, etc.

Radical initiators may be activated thermally, by radiation (such as UV radiation), a combination of two or more methods, etc.

In some embodiments, thermal crosslinking (such as that done using a radical initator) is preferably done between about 150 and 225° C. or more preferably between about 150 and 185° C.

Thermal cross linking may also be done in stages where, for example, the temperature is held at a certain point for a given period of time and then raised or lowered for another period of time. The temperature may also be ramped during the curing. Thermal and UV radiation cross-linking and/or other methods may be combined.

Radical initiators may include radical polymerization initiators, radical sources, etc., including organic and inorganic compounds. Examples include organic and inorganic peroxides (such as hydrogen peroxide, dialkyl peroxides, hydroperoxides, peracids, diacyl peroxides, peroxy esters, ketone peroxides, hydrocarbon peroxides, organometallic peroxides, organic polyoxides, organic polyoxides, dialkyl trioxides, hydrotrioxides, tetroxides, alkali metal peroxides (such as lithium peroxide), etc.), azo compounds, polyphenylhydrocarbons, substituted hydrazines, alkoxyamines, nitrocompounds, nitrates, nitrites, nitroxides, disulfides, polysulfides, persulfates (e.g. potassium persulfate, etc.), etc.

Examples of peroxides include, but are not limited to dibenzoyl peroxide, dicumyl peroxide, acetone peroxide, methyl ethyl ketone peroxide, lauroyl peroxide, tert-butyl peroxide, tert-butyl peracetate, di-tert-amyl peroxide, tert-butyl hydroperoxide, cumene hydroperoxide, 1,3-bis-(tert-butylperoxy-1-propyl) benzene, bis-(tert-butylperoxy) valerate, bis-(2,4-dichlorobenzoyl) peroxide, etc.

Examples of azo compounds include azobisisobutylonitrile (AIBN); 1,1′-azobis(cyclohexanecarbonitrile) (ABCN); 2,2′-azobis(2-methylbutyronitrile); 2,2′-azobis(2-methylpropionitrile); 2,2′-azobis(2-methylpropionitrile); N-tert-butyl-N-(2-methyl-1-phenylpropyl)-O-(1-phenylethyl)hydroxylamine, etc.

In some embodiments, the initiators are preferably used in about 5 weight percent to about 200 weight percent, or more preferably in about 5 weight percent to about 100 weight percent, or yet more in about 50 weight percent to about 100 weight percent, based on the total weight of the graphene sheets and/or graphite oxide.

One or more crosslinking promoters or coagents may be used. Examples include multifunctional (e.g. those containing at least two unsaturated radical polymerizable functional groups such as vinyl and other alkenyl groups) small molecules, oligomers, and polymers, etc. These may include, but are not limited to difunctional and trifunctional monomers; polybutadienes (including polybutadiene diacrylates, high vinyl polybutadiene, low molecular weight hydroxyl terminated polybutadienes and their esters, and the like); and diols, glycols, and polyethers (such as 1,4-butanediol, 1,6-hexanediol, poly(ethylene glycols), di(methylene glycol), di(ethylene glycol), di(butylene glycol), tri(propylene glycol), cyclohexanediols, 1,3-butylene glycol, etc.) that are terminated and/or otherwise substituted with two or more unsaturated radical polymerizable groups such as acrylates and methacrylates (examples of which include those manufactured by Sartomer Co., Inc., Exton Pa.). Examples also include di- and triallyl compounds, diacrylates and dimethacrylates, trifunctional (meth)acrylate esters, etc., such as N-N′-m-phenylenedimaleidmide, triallyl cyanurate (TAC), triallyl isocyanurate (TAIC), poly(butadiene) diacrylate, trimethylolpropane tri(meth)acrylate (TMPT), calcium di(meth)acrylate, trimethylolpropane tri(meth)acrylate, etc.

Graphite oxide (also known as graphitic acid or graphene oxide) may be produced by any suitable method, such as by a process that involves oxidation of graphite using one or more chemical oxidizing agents and, optionally, intercalating agents such as sulfuric acid. Examples of oxidizing agents include nitric acid, sodium and potassium nitrates, perchlorates, hydrogen peroxide, sodium and potassium permanganates, phosphorus pentoxide, bisulfites, etc. Preferred oxidants include KClO₄; HNO₃ and KClO₃; KMnO₄ and/or NaMnO₄; KMnO₄ and NaNO₃; K₂S₂O₈ and P₂O₅ and KMnO₄; KMnO₄ and HNO₃; and HNO₃. Preferred intercalation agents include sulfuric acid. Graphite may also be treated with intercalating agents and electrochemically oxidized. Examples of methods of making graphite oxide include those described by Staudenmaier (Ber. Stsch. Chem. Ges. (1898), 31, 1481) and Hummers (J. Am. Chem. Soc. (1958), 80, 1339).

The graphene sheets are graphite sheets preferably having a surface area of from about 100 to about 2630 m²/g. In some embodiments, the graphene sheets primarily, almost completely, or completely comprise fully exfoliated single sheets of graphite (these are approximately 1 nm thick and are often referred to as “graphene”), while in other embodiments, at least a portion of the graphene sheets may comprise at partially exfoliated graphite sheets, in which two or more sheets of graphite have not been exfoliated from each other. The graphene sheets may comprise mixtures of fully and partially exfoliated graphite sheets.

Graphene sheets may be made using any suitable method. For example, they may be obtained from graphite, graphite oxide, expandable graphite, expanded graphite, etc. They may be obtained by the physical exfoliation of graphite, by for example, peeling off sheets graphene sheets. They may be made from inorganic precursors, such as silicon carbide. They may be made by chemical vapor deposition (such as by reacting a methane and hydrogen on a metal surface). They may be may by the reduction of an alcohol, such ethanol, with a metal (such as an alkali metal like sodium) and the subsequent pyrolysis of the alkoxide product (such a method is reported in Nature Nanotechnology (2009), 4, 30-33). They may be made by the exfoliation of graphite in dispersions or exfoliation of graphite oxide in dispersions and the subsequently reducing the exfoliated graphite oxide. Graphene sheets may be made by the exfoliation of expandable graphite, followed by intercalation, and ultrasonication or other means of separating the intercalated sheets (see, for example, Nature Nanotechnology (2008), 3, 538-542). They may be made by the intercalation of graphite and the subsequent exfoliation of the product in suspension, thermally, etc.

Graphene sheets may be made from graphite oxide. Graphite may be treated with oxidizing and/or intercalating agents and exfoliated. Graphite may also be treated with intercalating agents and electrochemically oxidized and exfoliated. Graphene sheets may be formed by ultrasonically exfoliating suspensions of graphite and/or graphite oxide in a liquid (which may contain surfactants and/or intercalants). Exfoliated graphite oxide dispersions or suspensions can be subsequently reduced to graphene sheets. Graphene sheets may also be formed by mechanical treatment (such as grinding or milling) to exfoliate graphite or graphite oxide (which would subsequently be reduced to graphene sheets).

Reduction of graphite oxide to graphene sheets may be by means of chemical reduction and may be carried out on graphite oxide in a solid form, in a dispersion, etc. Examples of useful chemical reducing agents include, but are not limited to, hydrazines (such as hydrazine, N,N-dimethylhydrazine, etc.), sodium borohydride, citric acid, hydroquinone, isocyanates (such as phenyl isocyanate), hydrogen, hydrogen plasma, etc. For example, a dispersion of exfoliated graphite oxide in a carrier (such as water, organic solvents, or a mixture of solvents) can be made using any suitable method (such as ultrasonication and/or mechanical grinding or milling) and reduced to graphene sheets.

One example of a method for the preparation of graphene sheets is to oxidize graphite to graphite oxide, which is then thermally exfoliated to form graphene sheets (also known as thermally exfoliated graphite oxide), as described in US 2007/0092432, the disclosure of which is hereby incorporated herein by reference. The thusly formed graphene sheets may display little or no signature corresponding to graphite or graphite oxide in their X-ray diffraction pattern.

The thermal exfoliation can be done in a batch process or a continuous process and can be done under a variety of atmospheres, including inert and reducing atmospheres (such as nitrogen, argon, and/or hydrogen atmospheres). Heating times can range from under a few seconds or several hours or more, depending on the temperatures used and the characteristics desired in the final thermally exfoliated graphite oxide. Heating can be done in any appropriate vessel, such as a fused silica, mineral, metal, carbon (such as graphite), ceramic vessel, etc vessel. Heating may be done using a flash lamp.

During heating, the graphite oxide may be contained in an essentially constant location in single batch reaction vessel, or may be transported through one or more vessels during the reaction in a continuous or batch mode. Heating may be done using any suitable means, including the use of furnaces and infrared heaters.

Examples of temperatures at which the thermal exfoliation of graphite oxide may be carried out are at least about 300° C., at least about 400° C., at least about 450° C., at least about 500° C., at least about 600° C., at least about 700° C., at least about 750° C., at least about 800° C., at least about 850° C., at least about 900° C., at least about 950° C., and at least about 1000° C. Preferred ranges include between about 750 about and 3000° C., between about 850 and 2500° C., between about 950 and about 2500° C., and between about 950 and about 1500° C.

The time of heating can range from less than a second to many minutes. For example, the time of heating can be less than about 0.5 seconds, less than about 1 second, less than about 5 seconds, less than about 10 seconds, less than about 20 seconds, less than about 30 seconds, or less than about 1 min. The time of heating can be at least about 1 minute, at least about 2 minutes, at least about 5 minutes, at least about 15 minutes, at least about 30 minutes, at least about 45 minutes, at least about 60 minutes, at least about 90 minutes, at least about 120 minutes, at least about 150 minutes, at least about 240 minutes, from about 0.01 seconds to about 240 minutes, from about 0.5 seconds to about 240 minutes, from about 1 second to about 240 minutes, from about 1 minute to about 240 minutes, from about 0.01 seconds to about 60 minutes, from about 0.5 seconds to about 60 minutes, from about 1 second to about 60 minutes, from about 1 minute to about 60 minutes, from about 0.01 seconds to about 10 minutes, from about 0.5 seconds to about 10 minutes, from about 1 second to about 10 minutes, from about 1 minute to about 10 minutes, from about 0.01 seconds to about 1 minute, from about 0.5 seconds to about 1 minute, from about 1 second to about 1 minute, no more than about 600 minutes, no more than about 450 minutes, no more than about 300 minutes, no more than about 180 minutes, no more than about 120 minutes, no more than about 90 minutes, no more than about 60 minutes, no more than about 30 minutes, no more than about 15 minutes, no more than about 10 minutes, no more than about 5 minutes, no more than about 1 minute, no more than about 30 seconds, no more than about 10 seconds, or no more than about 1 second. During the course of heating, the temperature may vary.

Examples of the rate of heating include at least about 120° C./min, at least about 200° C./min, at least about 300° C./min, at least about 400° C./min, at least about 600° C./min, at least about 800° C./min, at least about 1000° C./min, at least about 1200° C./min, at least about 1500° C./min, at least about 1800° C./min, and at least about 2000° C./min.

Graphene sheets may be annealed or reduced to graphene sheets having higher carbon to oxygen ratios by heating under reducing atmospheric conditions (e.g., in systems purged with inert gases or hydrogen). Reduction/annealing temperatures are preferably at least about 300° C., or at least about 350° C., or at least about 400° C., or at least about 500° C., or at least about 600° C., or at least about 750° C., or at least about 850° C., or at least about 950° C., or at least about 1000° C. The temperature used may be, for example, between about 750 about and 3000° C., or between about 850 and 2500° C., or between about 950 and about 2500° C.

The time of heating can be for example, at least about 1 second, or at least about 10 second, or at least about 1 minute, or at least about 2 minutes, or at least about 5 minutes. In some embodiments, the heating time will be at least about 15 minutes, or about 30 minutes, or about 45 minutes, or about 60 minutes, or about 90 minutes, or about 120 minutes, or about 150 minutes. During the course of annealing/reduction, the temperature may vary within these ranges.

The heating may be done under a variety of conditions, including in an inert atmosphere (such as argon or nitrogen) or a reducing atmosphere, such as hydrogen (including hydrogen diluted in an inert gas such as argon or nitrogen), or under vacuum. The heating may be done in any appropriate vessel, such as a fused silica or a mineral or ceramic vessel or a metal vessel. The materials being heated including any starting materials and any products or intermediates) may be contained in an essentially constant location in single batch reaction vessel, or may be transported through one or more vessels during the reaction in a continuous or batch reaction. Heating may be done using any suitable means, including the use of furnaces and infrared heaters.

The graphene sheets preferably have a surface area of at least about 100 m²/g to, or of at least about 200 m²/g, or of at least about 300 m²/g, or of least about 350 m²/g, or of least about 400 m²/g, or of least about 500 m²/g, or of least about 600 m²/g, or of least about 700 m²/g, or of least about 800 m²/g, or of least about 900 m²/g, or of least about 700 m²/g. The surface area may be about 400 to about 1100 m²/g. The theoretical maximum surface area can be calculated to be 2630 m²/g. The surface area includes all values and subvalues therebetween, especially including 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets can have number average aspect ratios of about 100 to about 100,000, or of about 100 to about 50,000, or of about 100 to about 25,000, or of about 100 to about 10,000 (where “aspect ratio” is defined as the ratio of the longest dimension of the sheet to the shortest).

Surface area can be measured using either the nitrogen adsorption/BET method at 77 K or a methylene blue (MB) dye method in liquid solution. The dye method is carried out as follows: A known amount of graphene sheets is added to a flask. At least 1.5 g of MB are then added to the flask per gram of graphene sheets. Ethanol is added to the flask and the mixture is ultrasonicated for about fifteen minutes. The ethanol is then evaporated and a known quantity of water is added to the flask to re-dissolve the free MB. The undissolved material is allowed to settle, preferably by centrifuging the sample. The concentration of MB in solution is determined using a UV-vis spectrophotometer by measuring the absorption at λₘₐₓ=298 nm relative to that of standard concentrations.

The difference between the amount of MB that was initially added and the amount present in solution as determined by UV-vis spectrophotometry is assumed to be the amount of MB that has been adsorbed onto the surface of the graphene sheets. The surface area of the graphene sheets are then calculated using a value of 2.54 m² of surface covered per one mg of MB adsorbed.

The graphene sheets may have a bulk density of from about 0.1 to at least about 200 kg/m³. The bulk density includes all values and subvalues therebetween, especially including 0.5, 1, 5, 10, 15, 20, 25, 30, 35, 50, 75, 100, 125, 150, and 175 kg/m³.

The graphene sheets may be functionalized with, for example, oxygen-containing functional groups (including, for example, hydroxyl, carboxyl, and epoxy groups) and typically have an overall carbon to oxygen molar ratio (C/O ratio), as determined by elemental analysis of at least about 1:1, or more preferably, at least about 3:2. Examples of carbon to oxygen ratios include about 3:2 to about 85:15; about 3:2 to about 20:1; about 3:2 to about 30:1; about 3:2 to about 40:1; about 3:2 to about 60:1; about 3:2 to about 80:1; about 3:2 to about 100:1; about 3:2 to about 200:1; about 3:2 to about 500:1; about 3:2 to about 1000:1; about 3:2 to greater than 1000:1; about 10:1 to about 30:1; about 80:1 to about 100:1; about 20:1 to about 100:1; about 20:1 to about 500:1; about 20:1 to about 1000:1; about 50:1 to about 300:1; about 50:1 to about 500:1; and about 50:1 to about 1000:1. In some embodiments, the carbon to oxygen ratio is at least about 10:1, or at least about 20:1, or at least about 35:1, or at least about 50:1, or at least about 75:1, or at least about 100:1, or at least about 200:1, or at least about 300:1, or at least about 400:1, or at least 500:1, or at least about 750:1, or at least about 1000:1; or at least about 1500:1, or at least about 2000:1. The carbon to oxygen ratio also includes all values and subvalues between these ranges.

The graphene sheets may contain atomic scale kinks due to the presence of lattice defects in the honeycomb structure of the graphite basal plane. These kinks may in some cases be desirable to prevent the stacking of the single sheets back to graphite oxide and/or other graphite structures under the influence of van der Waals forces.

The graphene sheets and/or graphite oxide may comprise two or more powders having different particle size distributions and/or morphologies.

The compositions may be made by crosslinking graphene sheets, graphite oxide, or a mixture of graphene sheets and graphite oxide. Compositions obtained by crosslinking graphite oxide or a mixture of graphene oxide and graphene sheets may be partially or fully reduced and can be reduced to form crosslinked graphene sheets. Compositions comprising crosslinked graphene sheets can be further reduced such that the crosslinked graphene sheets have a higher carbon to oxygen molar ratio.

Reduction may be carried out using any suitable means. For example, chemical reduction can be done on the compositions in a solid form, dispersion, etc. Examples of useful chemical reducing agents include, but are not limited to, hydrazines (such as hydrazine, N,N-dimethylhydrazine, etc.), sodium borohydride, hydroquinone, isocyanates (such as phenyl isocyanate), hydrogen, hydrogen plasma, etc. Reduction can be carried out thermally as described above.

The compositions preferably contain less than about 2 percent polymer binder or matrix, or more preferably less than about 1 percent polymer binder or matrix, or more preferably less than about 0.5 percent polymer binder or matrix, or more preferably less than about 0.1 percent polymer binder or matrix, or more preferably less than about 0.01 percent polymer binder or matrix, or more preferably no added polymer binder or matrix, wherein the percentages are weight percentages based on the total amount of graphene sheets.

The compositions may optionally comprise one or more additional additives, such as dispersion aids (including surfactants, emulsifiers, and wetting aids), adhesion promoters, thickening agents (including clays), defoamers and antifoamers, biocides, additional fillers, flow enhancers, stabilizers, etc.

Examples of grinding aids include stearates (such as Al, Ca, Mg, and Zn stearates) and acetylenic diols (such as those sold by Air Products under the trade names Surfynol® and Dynol®).

Examples of adhesion promoters include titanium chelates and other titanium compounds such as titanium phosphate complexes (including butyl titanium phosphate), titanate esters, diisopropoxy titanium bis(ethyl-3-oxobutanoate, isopropoxy titanium acetylacetonate, and others sold by Johnson-Matthey Catalysts under the trade name Vertec®.

The compositions may optionally comprise at least one “multi-chain lipid”, by which term is meant a naturally-occurring or synthetic lipid having a polar head group and at least two nonpolar tail groups connected thereto. Examples of polar head groups include oxygen, sulfur-, and halogen-containing, phosphates, amides, ammonium groups, amino acids (including α-amino acids), saccharides, polysaccharides, esters (Including glyceryl esters), zwitterionic groups, etc.

The tail groups may be the same or different. Examples of tail groups include alkanes, alkenes, alkynes, aromatic compounds, etc. They may be hydrocarbons, functionalized hydrocarbons, etc. The tail groups may be saturated or unsaturated. They may be linear or branched. The tail groups may be derived from fatty acids, such as oleic acid, palmitic acid, stearic acid, arachidic acid, erucic acid, arachadonic acid, linoleic acid, linolenic acid, oleic acid, etc.

Examples of multi-chain lipids include, but are not limited to, lecithin and other phospholipids (such as phosphoglycerides (including phosphatidylserine, phosphatidylinositol, phosphatidylethanolamine (cephalin), and phosphatidylglycerol) and sphingomyelin); glycolipids (such as glucosyl-cerebroside); saccharolipids; sphingolipids (such as ceramides, di- and triglycerides, phosphosphingolipids, and glycosphingolipids); etc. They may be amphoteric, including zwitterionic.

The compositions may optionally comprise one or more charged organic compounds. The charged organic compound comprises at least one ionic functional group and one hydrocarbon-based chain. Examples of ionic functional groups include ammonium salts, sulfates, sulphonates, phosphates, carboxylates, etc. If two or more ionic functional groups are present, they may be of the same or different types. The compound may comprise additional functional groups, including, but not limited to hydroxyls, alkenes, alkynes, carbonyl groups (such as carboxylic acids, esters, amides, ketones, aldehydes, anhydrides, thiol, etc.), ethers, fluoro, chloro, bromo, iodo, nitriles, nitrogen containing groups, phosphorous containing groups, silicon containing groups, etc.

The compound comprises at least one hydrocarbon-based chain. The hydrocarbon-based chain may be saturated or unsaturated and may be branched or linear. It may be an alkyl group, alkenyl group, alkynyl group, etc. It need not contain only carbon and hydrogen atoms. It may be substituted with other functional groups (such as those mentioned above). Other functional groups, such as esters, ethers, amides, may be present in the length of the chain. In other words, the chain may contain two or more hydrocarbon-based segments that are connected by one or more functional groups. In one embodiment, at least one ionic functional group is located at the end of a chain.

Examples of ammonium salts include materials having the formula: R¹R²R³R⁴N⁺X⁻, where R¹, R², and R³, are each independently H, a hydrocarbon-based chain, an aryl-containing group, an alicyclic group; an oligomeric group, a polymeric group, etc.; where R⁴ is a hydrocarbon-based chain having at least four carbon atoms; and where X⁻ is an anion such as fluoride, bromide, chloride, iodide, sulfate, hydroxide, carboxylate, etc. Any of the R groups may have one or more additional ammonium groups.

Examples of R groups include methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, C₂₁ to C₄₀ chains, etc.

Examples of quaternary ammonium salts include tetraalkylammonium salts, dialkyldimethylammonium salts, alkyltrimethylammonium salts, where the alkyl groups are one or more groups containing at least eight carbon atoms. Examples include tetradodecylammonium, tetradecyltrimethylammonium halide, hexadecyltrimethylammonium halide, didodecyldimethylammonium halide, etc.

Ammonium salts may be bis- or higher order ammonium salts, including quaternary ammonium salts. They may be salts of carboxylic acids, dicarboxylic acids, tricarboxylic acids, and higher carboxylic acids. The carboxylic acids may have be part of a hydrocarbon-based chain having at least about four linear carbon atoms. Examples include ammonium salts of octanoic acid, nonanoic acid, decanoic acid, undecanoic acid, dodecanoic acid, tridecanoic acid, tetradecanoic acid, pentadecanic acid, carboxylic acids having at least 15 carbon atoms, stearic acid, oleic acid, montanic acid, apidic acid, 1,7-heptanedioic acid, 1,8-octandioic acid, 1,9-nonanedioic acid, sebacic acid, 1,11-undecandioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid, 1,18-octadecanedioic acid, 1,19-nonadecanedioic acid, 1,20-eicosanedioic acid, dicarboxylic acids having 21 to 40 carbon atoms, etc.

Alkylol ammonium salts of carboxylic acids (including high molecular weight carboxylic acids and unsaturated carboxylic acids) may be used. Examples include EFKA 5071, an alkylol ammonium salt of a high-molecular weight carboxylic acid supplied by Ciba and BYK-ES80, an alkylolammonium salt of an unsaturated acidic carboxylic acid ester manufactured by BYK USA, Wallingford, Conn.

The charged organic compound may have a sulfur containing group such as a sulphonate, mesylate, triflate, tosylate, besylate, sulfates, sulfite, peroxomonosulfate, peroxodisulfate, pyrosulfate, dithionate, metabisulfite, dithionite, thiosulfate, tetrathionate, etc. The organic compound may also contain two or more sulfur containing groups.

Alkyl, alkenyl, and/or alkynyl sulfates and sulphonates are preferred sulfur-containing compounds. The alkyl, alkenyl, and/or alkynyl groups preferably contain at least about 8 carbon atoms, or more preferably at least about 10 carbon atoms. Examples include decylsulfate salts, dodecylsulfate salts (such as sodium 1-dodecanesulfate (SDS)), decylsulfonate salts, dodecylsulfonate salts (such as sodium 1-dodecanesulfonate (SDSO)), etc. The counter ions may be any suitable cations, such as lithium, sodium, potassium, ammonium, etc.

The charged organic compound may be present in about 1 to about 75 weight percent, in about 2 to about 70 weight percent, in about 2 to about 60 weight percent, in about 2 to about 50 weight percent, in about 5 to about 50 weight percent, in about 10 to about 50 weight percent, in about 10 to about 40 weight percent, in about 20 to about 40 weight percent, based on the total weight of graphene sheets and/or graphite oxide.

The crosslinked graphene sheet and/or graphite oxide composition may have a thickness of a single layer of graphene or two or more layers. The number of layers of graphene sheets and/or graphite oxide may vary throughout the composition.

In some cases, the crosslinked graphene sheets and/or graphite oxide compositions can have a thickness of at least about 1 nm, of at least about 2 nm, or at least about 5 nm. In various embodiments, the compositions can have a thickness of about 2 nm to 2 mm, about 5 nm to 1 mm, about 2 nm to about 100 nm, about 2 nm to about 200 nm, about 2 nm to about 500 nm, about 2 nm to about 1 micrometer, about 5 nm to about 200 nm, about 5 nm to about 500 nm, about 5 nm to about 1 micrometer, about 5 nm to about 50 micrometers, about 5 nm to about 200 micrometers, about 10 nm to about 200 nm, about 50 nm to about 500 nm, about 50 nm to about 1 micrometer, about 100 nm to about 10 micrometers, about 1 micrometer to about 2 mm, about 1 micrometer to about 1 mm, about 1 micrometer to about 500 micrometers, about 1 micrometer to about 200 micrometers, about 1 micrometer to about 100 micrometers, about 50 micrometers to about 1 mm, about 100 micrometers to about 2 mm, about 100 micrometers to about 1 mm, about 100 micrometers to about 750 micrometers, about 100 micrometers to about 500 micrometers, about 500 micrometers to about 2 mm, or about 500 micrometers to about 1 mm.

The compositions can be electrically conductive. They can have a conductivity of at least about 10⁻⁸ S/m. They can have a conductivity of about 10⁻⁶ S/m to about 10⁵ S/m, or of about 10⁻⁵ S/m to about 10⁵ S/m. In other embodiments of the invention, the compositions have conductivities of at least about 0.001 S/m, of at least about 0.01 S/m, of at least about 0.1 S/m, of at least about 1 S/m, of at least about 10 S/m, of at least about 100 S/m, or at least about 1000 S/m, or at least about 10,000 S/m, or at least about 20,000 S/m, or at least about 30,000 S/m, or at least about 40,000 S/m, or at least about 50,000 S/m, or at least about 60,000 S/m, or at least about 75,000 S/m, or at least about 10⁵ S/m, or at least about 10⁶ S/m. In some embodiments, the surface resistivity of the compositions may be no greater than about 10000 Ω/square, or no greater than about 5000 Ω/square, or no greater than about 1000 Ω/square or no greater than about 700 Ω/square, or no greater than about 500 Ω/square, or no greater than about 350 Ω/square, or no greater than about 200 Ω/square, or no greater than about 200 Ω/square, or no greater than about 150 Ω/square, or no greater than about 100 Ω/square, or no greater than about 75 Ω/square, or no greater than about 50 Ω/square, or no greater than about 30 Ω/square, or no greater than about 20 Ω/square, or no greater than about 10 Ω/square, or no greater than about 5 Ω/square, or no greater than about 1 Ω/square, or no greater than about 0.1 Ω/square, or no greater than about 0.01 Ω/square, or no greater than about 0.001 Ω/square.

The compositions can have a thermal conductivity of about 0.1 to about 50 W/(m-K), or of about 0.5 to about 30 W/(m-K), or of about 1 to about 30 W/(m-K), or of about 1 to about 20 W/(m-K), or of about 1 to about 10 W/(m-K), or of about 1 to about 5 W/(m-K), or of about 2 to about 25 W/(m-K), or of about 5 to about 25 W/(m-K).

The compositions can be made from graphene sheets and/or graphite oxide in dry form, slurries, pastes, suspensions or dispersions, etc. For example, the graphene sheets and/or graphite oxide can be compressed (such as by pressure or suction) together in the presence of a crosslinking agent, if used, and then crosslinked.

In one embodiment the graphene sheets and/or graphite oxide are formed into a coating (such as one in the form of a dispersion, suspension, slurry, etc.) comprising a carrier. The coating is applied to a substrate and the graphene sheets and/or graphite oxide is crosslinked. The carrier may also be optionally removed before and/or after crosslinking. The compositions can be further reduced or annealed after they have been applied to the substrate before and/or after crosslinking.

Coatings (which may include inks) may be made using any suitable method, including wet or dry methods and batch, semi-continuous, and continuous methods. Graphene sheets and/or graphite oxide and, optionally, other components and/or carriers may be blended by using suitable mixing, dispersing, and/or compounding techniques and apparatus, including ultrasonic devices, high-shear mixers, two-roll mills, three-roll mills, cryogenic grinding crushers, extruders, kneaders, double planetary mixers, triple planetary mixers, high pressure homogenizers, ball mills, attrition equipment, sandmills, and horizontal and vertical wet grinding mills, etc.

The resulting blends may be further processed by grinding using wet or dry grinding technologies. The technologies can be continuous or discontinuous. Examples include ball mills, attrition equipment, sandmills, and horizontal and vertical wet grinding mills. Suitable materials for use as grinding media include metals, carbon steel, stainless steel, ceramics, stabilized ceramic media (such as yttrium stabilized zirconium oxide), PTFE, glass, tungsten carbide, etc. After blending and/or grinding steps, additional components may be added to the coatings.

Methods such as these can be used to change the particle size and/or morphology of the graphene sheets and/or graphite oxide, other components, and blends or two or more components.

Components may be processed together or separately and may go through multiple processing (including mixing/blending) stages, each involving one or more components (including blends).

There is no particular limitation to the way in which the graphene sheets and/or graphite oxide, and other components are processed and combined. For example, graphene sheets and/or graphite oxide may be processed into given particle size distributions and/or morphologies separately and then combined for further processing with or without the presence of additional components. Unprocessed graphene sheets and/or graphite oxide may be combined with processed graphene sheets and/or graphite oxide and further processed with or without the presence of additional components. Processed and/or unprocessed graphene sheets and/or processed and/or unprocessed graphite oxide may be combined with other components, such as one or more binders and then combined with processed and/or unprocessed graphene sheets and/or processed and/or unprocessed graphite oxide. Two or more combinations of processed and/or unprocessed graphene sheets and/or processed and/or unprocessed graphite oxide that have been combined with other components may be further combined or processed.

Coatings may optionally comprise one or more carriers in which some or all of the components are dissolved, suspended, or otherwise dispersed or carried. Examples of suitable carriers include, but are not limited to, water, distilled or synthetic isoparaffinic hydrocarbons (such Isopar® and Norpar® (both manufactured by Exxon) and Dowanol® (manufactured by Dow), citrus terpenes and mixtures containing citrus terpenes (such as Purogen, Electron, and Positron (all manufactured by Ecolink)), terpenes and terpene alcohols (including terpineols, including alpha-terpineol), limonene, aliphatic petroleum distillates, alcohols (such as methanol, ethanol, n-propanol, i-propanol, n-butanol, i-butanol, sec-butanol, tert-butanol, pentanols, i-amyl alcohol, hexanols, heptanols, octanols, diacetone alcohol, butyl glycol, etc.), ketones (such as acetone, methyl ethyl ketone, cyclohexanone, i-butyl ketone, 2,6,8,trimethyl-4-nonanone etc.), esters (such as methyl acetate, ethyl acetate, n-propyl acetate, i-propyl acetate, n-butyl acetate, i-butyl acetate, tert-butyl acetate, carbitol acetate, etc.), glycol ethers, ester and alcohols (such as 2-(2-ethoxyethoxy)ethanol, propylene glycol monomethyl ether and other propylene glycol ethers; ethylene glycol monobutyl ether, 2-methoxyethyl ether (diglyme), propylene glycol methyl ether (PGME); and other ethylene glycol ethers; ethylene and propylene glycol ether acetates, diethylene glycol monoethyl ether acetate, 1-methoxy-2-propanol acetate (PGMEA); and hexylene glycol (such as Hexasol™ (supplied by SpecialChem)), imides, amides (such as dimethyl formamide, dimethylacetamide, etc.), cyclic amides (such as N-methylpyrrolidone and 2-pyrrolidone), lactones (such as beta-propiolactone, gamma-valerolactone, delta-valerolactone, gamma-butyrolactone, epsilon-caprolactone), cyclic imides (such as imidazolidinones such as N,N′-dimethylimidazolidinone (1,3-dimethyl-2-imidazolidinone)). and mixtures of two or more of the foregoing and mixtures of one or more of the foregoing with other carriers. Solvents may be low- or non-VOC solvents, non-hazardous air pollution solvents, and non-halogenated solvents.

The coatings may be applied to a wide variety of substrates, including, but not limited to, flexible and/or stretchable materials, silicones and other elastomers and other polymeric materials, metals (such as aluminum, copper, steel, stainless steel, etc.), adhesives, fabrics (including cloths) and textiles (such as cotton, wool, polyesters, rayon, etc.), clothing, glasses and other minerals, ceramics, silicon surfaces, wood, paper, cardboard, paperboard, cellulose-based materials, glassine, labels, silicon and other semiconductors, laminates, corrugated materials, concrete, bricks, and other building materials, etc. Substrates may in the form of films, papers, wafers, larger three-dimensional objects, etc.

The substrates may have been treated with other materials such as coatings (such as paints) or similar materials before the coatings are applied. Examples include substrates (such as PET) coated with indium tin oxide, antimony tin oxide, etc. They may be woven, nonwoven, in mesh form; etc. They may be woven, nonwoven, in mesh form; etc.

The substrates may be paper-based materials generally (including paper, paperboard, cardboard, glassine, etc.). Paper-based materials can be surface treated. Examples of surface treatments include coatings such as polymeric coatings, which can include PET, polyethylene, polypropylene, acetates, nitrocellulose, etc. Coatings may be adhesives. The paper based materials may be sized.

Examples of polymeric materials include, but are not limited to, those comprising thermoplastics and thermosets, including elastomers and rubbers (including thermoplastics and thermosets), silicones, fluorinated polysiloxanes, natural rubber, butyl rubber, chlorosulfonated polyethylene, chlorinated polyethylene, styrene/butadiene copolymers (SBR), styrene/ethylene/butadiene/stryene copolymers (SEBS), styrene/ethylene/butadiene/stryene copolymers grafted with maleic anhydride, styrene/isoprene/styrene copolymers (SIS), polyisoprene, nitrile rubbers, hydrogenated nitrile rubbers, neoprene, ethylene/propylene copolymers (EPR), ethylene/propylene/diene copolymers (EPDM), ethylene/vinyl acetate copolymer (EVA), hexafluoropropylene/vinylidene fluoride/tetrafluoroethylene copolymers, tetrafluoroethylene/propylene copolymers, fluorelastomers, polyesters (such as poly(ethylene terephthalate), poly(butylene terephthalate), poly(ethylene naphthalate), liquid crystalline polyesters, poly(lactic acid), etc).; polystyrene; polyamides (including polyterephthalamides); polyimides; (such as Kapton®); aramids (such as Kevlar® and Nomex®); fluoropolymers (such as fluorinated ethylene propylene (FEP), polytetrafluoroethylene (PTFE), poly(vinyl fluoride), poly(vinylidene fluoride), etc.); polyetherimides; poly(vinyl chloride); poly(vinylidene chloride); polyurethanes (such as thermoplastic polyurethanes (TPU); spandex, cellulosic polymers; (such as nitrocellulose, cellulose acetate, etc.); styrene/acrylonitriles polymers (SAN); arcrylonitrile/butadiene/styrene polymers (ABS); polycarbonates; polyacrylates; poly(methyl methacrylate); ethylene/vinyl acetate copolymers; thermoset epoxies and polyurethanes; polyolefins (such as polyethylene (including low density polyethylene, high density polyethylene, ultrahigh molecular weight polyethylene, etc.), polypropylene (such as biaxially-oriented polypropylene, etc.); Mylar; etc. They may be non-woven materials, such as DuPont Tyvek®. They may be adhesive materials.

The substrate may be a transparent or translucent or optical material, such as glass, quartz, polymer (such as polycarbonate or poly(meth)acrylates (such as poly(methyl methacrylate).

The coatings may be applied to the substrate using any suitable method, including, but not limited to, painting, pouring, spin casting, solution casting, dip coating, powder coating, lamination, extrusion, by syringe or pipette, spray coating, curtain coating, lamination, co-extrusion, electrospray deposition, ink-jet printing, spin coating, thermal transfer (including laser transfer) methods, doctor blade printing, screen printing, rotary screen printing, gravure printing, capillary printing, offset printing, electrohydrodynamic (EHD) printing (a method of which is described in WO 2007/053621, which is hereby incorporated herein by reference), flexographic printing, pad printing, stamping, xerography, microcontact printing, dip pen nanolithography, laser printing, via pen or similar means, etc. The coatings can be applied in multiple layers.

When applied to a substrate, compositions can have a variety of forms. They can be present as a film or lines, patterns, letters, numbers, circuitry, logos, identification tags, and other shapes and forms. The compositions may be covered in whole or in part with additional material, such as overcoatings, varnishes, polymers, fabrics, etc.

The compositions can be present on the same substrate in varying thicknesses at different points and can be used to build up three-dimensional structures on the substrate.

The crosslinked graphene sheets and/or graphite oxide may be in the form of a paper, film, mesh, screen, fabric, surface coating, etc.

They may be used as filters, clothing (such as protective clothing), membranes, gaskets, electronic components (such as battery or supercapacitor electrodes, etc.), displays (such as electroluminescent displays).

In some cases, some compositions may be suitable for in applications requiring electrical conductivity, EMI shielding, barrier (such as to the permeation of gases and/or liquids) properties, thermal conductivity, static dissipativity, chemical resistance, etc.

The compositions can be used for the passivation of surfaces, such as metal (e.g. steel, aluminum, etc.) surfaces, including exterior structures such as bridges and buildings. Examples of other uses of the compositions include: UV radiation resistant coatings, abrasion resistant coatings, coatings having permeation resistance to liquids (such as hydrocarbon, alcohols, water, etc.) and/or gases, electrically conductive coatings, static dissipative coatings, and blast and impact resistant coatings. They can be used to make fabrics having electrical conductivity. The compositions can be used in solar cell applications; solar energy capture applications; signage, flat panel displays; flexible displays, including light-emitting diode, organic light-emitting diode, and polymer light-emitting diode displays; backplanes and frontplanes for displays; and lighting, including electroluminescent and OLED lighting. The displays may be used as components of portable electronic devices, such as computers, cellular telephones, games, GPS receivers, personal digital assistants, music players, calculators, artificial “paper” and reading devices, etc.

They may be used in packaging and/or to make labels. They may be used in inventory control and anti-counterfeiting applications (such as for pharmaceuticals), including package labels. They may be used to make smart packaging and labels (such as for marketing and advertisement, information gathering, inventory control, information display, etc.). They may be used to form a Faraday cage in packaging, such as for electronic components.

The compositions can be used on electrical and electronic devices and components, such as housings etc., to provide EMI shielding properties. They made be used in microdevices (such as microelectromechanical systems (MEMS) devices) including to provide antistatic coatings.

They may be used in the manufacture of housings, antennas, and other components of portable electronic devices, such as computers, cellular telephones, games, navigation systems, personal digital assistants, music players, games, calculators, radios, artificial “paper” and reading devices, etc.

The compositions can be used to form thermally conductive channels on substrates or to form membranes having desired flow properties and porosities. Such materials could have highly variable and tunable porosities and porosity gradients can be formed. The coatings can be used to form articles having anisotropic thermal and/or electrical conductivities. The coatings can be used to form three-dimensional printed prototypes.

The compositions can be used to make printed electronic devices (also referred to as “printed electronics) that may be in the form of complete devices, parts or sub elements of devices, electronic components, etc. They can comprise a substrate onto at least one surface of which has been applied a layer of an electrically conductive coating comprising crosslinked graphene sheets and/or graphite oxide.

Printed electronics may be prepared by applying the compositions to a substrate in a pattern comprising an electrically conductive pathway designed to achieve the desired electronic device. The pathway may be solid, mostly solid, in a liquid or gel form, etc.

The printed electronic devices may take on a wide variety of forms and be used in a large array of applications. They may contain multiple layers of electronic components (e.g. circuits) and/or substrates. All or part of the printed layer(s) may be covered or coated with another material such as a cover coat, varnish, cover layer, cover films, dielectric coatings, electrolytes and other electrically conductive materials, etc. There may also be one or more materials between the substrate and printed circuits. Layers may include semiconductors, metal foils, dielectric materials, etc.

The printed electronics may further comprise additional components, such as processors, memory chips, other microchips, batteries, resistors, diodes, capacitors, transistors, etc.

Other applications include, but are not limited to: passive and active devices and components; electrical and electronic circuitry, integrated circuits; flexible printed circuit boards; transistors; field-effect transistors; microelectromechanical systems (MEMS) devices; microwave circuits; antennas; diffraction gratings; indicators; chipless tags (e.g. for theft deterrence from stores, libraries, etc.); security and theft deterrence devices for retail, library, and other settings; key pads; smart cards; sensors; liquid crystalline displays (LCDs); signage; lighting; flat panel displays; flexible displays, including light-emitting diode, organic light-emitting diode, and polymer light-emitting diode displays; backplanes and frontplanes for displays; electroluminescent and OLED lighting; photovoltaic devices, including backplanes; product identifying chips and devices; membrane switches; batteries, including thin film batteries; electrodes; indicators; printed circuits in portable electronic devices (for example, cellular telephones, computers, personal digital assistants, global positioning system devices, music players, games, calculators, etc.); electronic connections made through hinges or other movable/bendable junctions in electronic devices such as cellular telephones, portable computers, folding keyboards, etc.); wearable electronics; and circuits in vehicles, medical devices, diagnostic devices, instruments, etc.

The electronic devices may be radiofrequency identification (RFID) devices and/or components thereof and/or radiofrequency communication device. Examples include, but are not limited to, RFID tags, chips, and antennas. The RFID devices may be ultrahigh frequency RFID devices, which typically operate at frequencies in the range of about 868 to about 928 MHz. Examples of uses for RFIDs are for tracking shipping containers, products in stores, products in transit, and parts used in manufacturing processes; passports; barcode replacement applications; inventory control applications; pet identification; livestock control; contactless smart cards; automobile key fobs; etc.

The electronic devices may also be elastomeric (such as silicone) contact pads and keyboards. Such devices can be used in portable electronic devices, such as calculators, cellular telephones, GPS devices, keyboards, music players, games, etc. They may also be used in myriad other electronic applications, such as remote controls, touch screens, automotive buttons and switches, etc.

### EXAMPLES

### Preparation of Test Samples

Coatings comprising liquid dispersions of graphene sheets are printed onto either a silicone rubber or poly(ethylene terephthalate) substrate using a #28 50 μm wire rod. The printed substrates are placed wet in an oven at 135° C. and cured for 1 hour. The printed films had a thickness of about 1 μm.

### Conductivity Measurements

Electrical conductivity is determined using a four-point probe method. A rectangular four-point probe is placed on a sample. A potential difference (about 5-20 V) is applied across the sample and the current (I) is monitored with a multimeter. Another multimeter is used to measure the voltage (V) across two points having a known separation along the direction of the current.

The resistance is measured using Ohm's law, i.e. R=V/I; where R, V, and I are the resistance, voltage, and current, respectively. Resistivity (σ) is found by the equation σ=RA/L, where A and L are the cross sectional area of the film through which current flows and the length over which the potential difference is measured, respectively. Conductivity (K) is found by the equation K=1/σ. A is calculated by using the measured thickness of the sample. The results are given in the tables.

### Preparation of Coatings

Graphene sheets having the approximate carbon to oxygen molar ratio indicated in Table 1 are ground in isopropyl alcohol (IPA) in a vertical ball mill for about six hours using 3/16″ stainless steel balls and then for about six hours at about 20-25° C. in an Eiger Mini 250 Type M250-VSE-TEFV horizontal grinding mill using 0.3 mm of 5% yttrium stabilized zirconium oxide grinding media. The resulting dispersion has a solids concentration of about 6 weight percent.

In the case of Examples 1 and 2, dicumyl peroxide (in a 1:1 ratio by weight based on the graphene sheets), is added to the dispersion and the resulting mixture is blended in a high shear mixer (a homogenizer having a roto-stator overhead stirrer) operating at about 33,000 RPM for about three minutes.

TABLE 1

| | Comp. | | | |
|---|---|---|---|---|
| | Ex. 1 | Example 1 | Comp. Ex. 2 | Example 2 |
| Graphene sheets | 15:1 | 15:1 | 130:1 | 130:1 |
| (C:O ratio) | | | | |
| Dicumyl peroxide | No | yes | no | yes |
| Electrical conductivity | 9 | 9 | 57 | 99 |
| on PET (S/cm) | | | | |
| Electrical conductivity | 11 | 4 | 35 | 38 |
| on silicone rubber | | | | |
| (S/cm) | | | | |

1. A composition, comprising crosslinked graphene sheets and/or graphite oxide.

2. The composition of claim 1, comprising graphene sheets.

3. The composition of claim 1, wherein the composition of claim 1, wherein the graphene sheets have a surface area of at least about 300 m²/g.

4. The composition of claim 1, wherein the graphene sheets have a surface area of at least about 400 m²/g.

5. The composition of claim 1, wherein the graphene sheets have a surface area of at least about 500 m²/g.

6. The composition of claim 1, wherein the graphene sheets have a carbon to oxygen molar ratio of at least about 25:1.

7. The composition of claim 1, wherein the graphene sheets have a carbon to oxygen molar ratio of at least about 75:1.

8. The composition of claim 1 having an electrical conductivity of at least about 10 S/cm.

9. The composition of claim 1 having an electrical conductivity of at least about 10² S/cm.

10. The composition of claim 1 in the form of a film.

11. A method of making a composition, comprising crosslinking graphene sheets and/or graphite oxide.

12. The method of claim 11, wherein the crosslinked graphene sheets and/or graphite oxide are reduced.

13. The method of claim 11, wherein a coating comprising graphene sheets and/or graphite oxide is applied to a substrate and the graphene sheets and/or graphite oxide are crosslinked.

14. The method of claim 11, wherein graphene sheets and/or graphite oxide are combined with at least one crosslinking agent and crosslinked.

15. The method of claim 11, wherein the cross-linking agent is a radical initiator.

16. The method of claim 11, wherein the cross-linking agent is a peroxide.

17. The method of claim 11, wherein the cross-linking agent is dicumyl peroxide and/or dibenzoyl peroxide.

18. The method of claim 11, wherein the graphene sheets and/or graphite oxide are combined with at least one crosslinking agent and crosslinked to form a film.

19. The method of claim 11, wherein the graphene sheets and/or graphite oxide have a surface area of at least about 300 m²/g.

20. The method of claim 11, wherein the graphene sheets and/or graphite oxide have a carbon to oxygen molar ratio of at least about 10:1.
